(19) United States
(12) Patent Application Publication
(10) Pub. No.: US 2020/0332586 A1
(43) Pub. Date: Oct. 22, 2020

(54) SWING DOOR OPERATOR

(71) Applicant: ASSA ABLOY ENTRANCE SYSTEMS AB, Landskrona (SE)

(72) Inventor: Sven-Gunnar Söderqvist, VALLÅKRA (SE)

(21) Appl. No.: 16/303,137

(22) PCT Filed: Jul. 1, 2017
(86) PCT No.: PCT/EP2017/063382

§ 371 Date: Nov. 19, 2018

(30) Foreign Application Priority Data
Jun. 3, 2016 (SE) 1630136-8

(51) Int. Cl. E05F 15/70; E05F 15/40; E05F 15/73

(52) U.S. Cl. CPC E05F 15/70; E05Y 2900/132; E05F 15/73; E05F 15/40

(57) ABSTRACT

The present invention relates to a swing door operator adapted for employing a first predetermined speed trajectory, or a first and a second predetermined speed trajectory in sequence, when opening a swing door leaf (1). The first predetermined speed trajectory comprises the swing door leaf (1) being moved from a closed position (C) to a first open position (A). The second predetermined speed trajectory comprises the swing door leaf (1) being moved from the first open position (A) to a second open position (B) at a reduced kinetic energy setting. The first speed trajectory is initiated in response to an opening command or an evacuation command received by the swing door operator. The second speed trajectory is initiated in response to an evacuation command received by the swing door operator when the door leaf (1) arrives at the first open position (A).

### FIELD OF THE INVENTION

The present invention relates to a swing door operator and a method of operating a swing door leaf, both during regular use and during evacuation.

### BACKGROUND OF THE INVENTION

Automatic door sets are regulated by standards such as the European standard EN16005, which defines, i.a., pedestrian protection requirements for door sets. These regulations define maximum kinetic energy, maximum closing force, opening and closing time, use of safety sensors, etc.

There are problems associated with swing door sets when the door leaf/leaves swing automatically into an escape route, which can be the case, e.g., when two building corridors are perpendicularly connected to each other. Since it is not permitted that the door leaf is arranged such that it could hit passers-by at full force when opening, swing door sets are usually equipped with safety sensors which sense the presence of an obstacle located within the opening path of the door leaf, and temporarily stop the door in its path. However, it is also undesirable to have the door leaf stop in a position, during evacuation, where the door leaf extends into the escape route, e.g. at 90° subsequently reducing the size of the escape route.

### SUMMARY OF THE INVENTION

It is an object of the present invention to mitigate the above problems, and to provide an improved swing door operator which provides a safer and a more energy efficient opening cycle to be used in a swing door set.

According to a first aspect of the present invention, these objects are achieved by a swing door operator adapted for employing a first predetermined speed trajectory, or a first and a second predetermined speed trajectory in sequence, when opening a swing door leaf, the first predetermined speed trajectory comprising the swing door leaf being moved from a closed position to a first open position, and the second predetermined speed trajectory comprising the swing door leaf being moved from the first open position to a second open position at a reduced kinetic energy setting, wherein the first speed trajectory is initiated in response to an opening command or an evacuation command received by the swing door operator, and wherein the second speed trajectory is initiated in response to an evacuation command received by the swing door operator, when the door leaf arrives at the first open position.

Such a solution allows safe and rapid door leaf opening during regular use as well as efficient evacuation procedures, due to fast and simple change over between speed trajectories. Further, this solution does not require any significant rebuilding of existing swing door sets other than exchange of the swing door operator.

In one embodiment, the first open position comprises the swing door leaf being arranged at a first angle, and the second open position comprises the swing door leaf being arranged at a second angle which is larger than the first angle.

The swing door operator may comprise at least one safety sensor for detecting objects located in an opening path of the swing door leaf, the safety sensor being fully active during the first predetermined speed trajectory, and being inhibited when the swing door leaf arrives at the first open position and an evacuation command has been received by the swing door operator, facilitating safe door leaf opening during regular everyday use while still allowing more efficient evacuation since the fully opened door leaf will be placed close to the wall instead of extending with its full width into the escape route.

Further, the swing door leaf may be moved with a maximum kinetic energy of 1.69 J during the second predetermined speed trajectory, significantly reducing the risk of injuring an individual passing by in the escape route.

According to a second aspect of the present invention, these objects are achieved by a swing door set comprising at least one of the above mentioned swing door leaves and at least one swing door operator.

According to a third aspect of the present invention, these objects are achieved by a method of operating at least one swing door leaf during evacuation of a building, the method comprising the steps of a) at least one swing door operator receiving one of an opening command or an evacuation command, b) the at least one swing door operator moving the at least one swing door leaf, along a first predetermined speed trajectory, from a closed position to a first open position in response to one of an opening command and an evacuation command, c1) wherein the door leaf, when arriving at the first open position after an opening command, remains at the first open position, and c2) wherein the door leaf, when arriving at the first open position after an evacuation command, is moved at a reduced kinetic energy setting, along a second predetermined speed trajectory, from the first open position to a second open position, allowing safe and rapid door leaf opening during regular use, and efficient evacuation procedures.

The first open position may comprise the swing door leaf being arranged at a first angle, and the second open position may comprise the swing door leaf being arranged at a second angle which is larger than the first angle.

In one embodiment, the method further comprises the step of initiating movement of the at least one swing door leaf, from the first or second open position to the closed position, when an opening command or an evacuation command no longer is received by the swing door operator.

Generally, all terms used in the claims are to be interpreted according to their ordinary meaning in the technical field, unless explicitly defined otherwise herein. All references to “a/an/the [element, device, component, means, etc.]” are to be interpreted openly as referring to at least one instance of said element, device, component, means, etc., unless explicitly stated otherwise. Further, by the term “comprising” it is meant “comprising but not limited to” throughout the application.

### BRIEF DESCRIPTION OF THE DRAWINGS

This, and other aspects of the present invention, will now be described in more detail, with reference to the appended drawings showing currently preferred embodiments of the invention.

FIG. 1 shows a schematic top view of an embodiment according to the present invention, wherein a door leaf is arranged in a closed position.

FIG. 2 shows a schematic top view of a further embodiment according to the present invention, wherein two door leaves are arranged in a closed position.

FIG. 3 shows a schematic top view of the embodiment according to FIG. 1, wherein the door leaf is arranged in a first open position.

FIG. 4 shows a schematic top view of the embodiment according to FIG. 1, wherein the door leaf is arranged in a second open position.

### DETAILED DESCRIPTION

As previously mentioned, there are several problems associated with automated swing door leaves opening into an escape route.

One solution to the problem of risking hitting a passer-by with too much force is to open the swing door leaf very slowly at low energy performance, which, for most swing door users, is unacceptable due to a significant increase in door opening time during regular use. The maximum allowed speed and the shortest allowable swing door leaf opening time is regulated for low energy performance. When using low energy performance, there is no need for sensors since the built-in safety functions connected to the speed reduction are considered sufficient. More specifically, according to EN16005, the force required to prevent a stopped swing door leaf from opening further, measured at the opening/closing edge of the swing door leaf in the direction of travel, shall not exceed 67 N at any point in the opening cycle. Further, the kinetic energy of a swing door leaf in motion shall not exceed 1.69 J. The maximum allowed speed of the swing door leaf is calculated using, i.a., the width and mass of the swing door leaf. Low energy performing swing door leaves are usually not provided with additional safety devices since the kinetic energy levels are not considered to be hazardous. Also, swing door leaves have to open from a closed position to an open check position, or 80°, in 3 seconds or longer. If the swing door leaf opens more than 90°, it has to continue at the same rate as the open check speed. “Open check” is the slowing down of the speed of the swing door leaf opening before being fully opened.

In order to provide safe swing door leaf opening at full energy performance, the swing door operator may be connected to safety sensors, sensing objects located in the path of the swing door leaf. The sensors allow the swing door leaf to be opened at full force to a pre-set open position, while stopping the movement of the swing door leaf earlier if an obstacle is detected. The sensors are arranged on the opening/closing edge of the swing door leaf. However, in order to open the swing door leaf more, e.g. up to 180° from the closed position, the sensors have to be shut off, since otherwise they will sense the oncoming wall and stop the movement of the swing door leaf too soon. Shutting off the sensors increases the risk of passers-by being hit with the full force of the swing door leaf and/or of being pinned between an open swing door leaf and its adjacent wall.

A swing door set generally refers to a swing door set having one or two swing door leaves, i.e. a single leaf swing door set or a double leaf swing door set, where each swing door leaf is hinged or pivoted to the door frame at one of its edges. Each swing door leaf has a main opening/closing edge, arranged opposite to the hinge/pivot edge. In other words, the main opening/closing edge refers to the edge of a swing door leaf whose distance from a parallel, opposing edge or surface determines the usable opening of the swing door set. A further term used is the opposing opening/closing edge which refers to either an edge formed by the main opening/closing edge of a counter closing swing door leaf, or a fixed edge or a surface against which the swing door leaf is moving, such as a door frame.

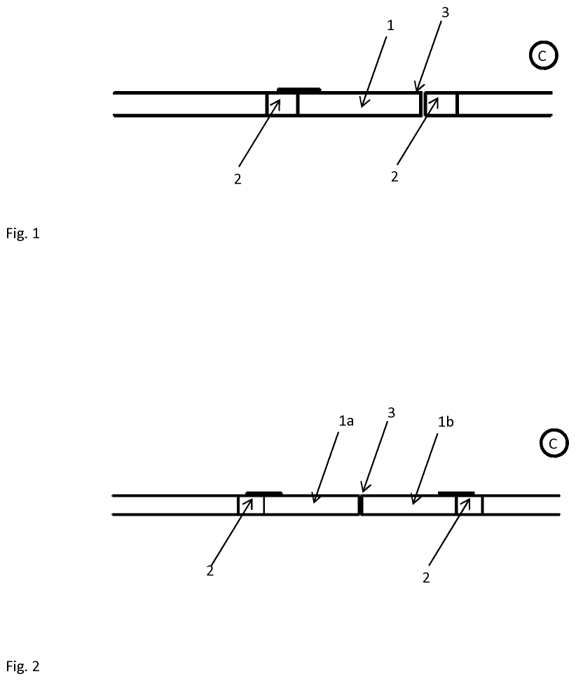

When the swing door set is provided with only one swing door leaf 1, as shown in FIG. 1, the swing door leaf 1 is hinged or pivoted at one edge to the door frame 2, while the main opening/closing edge 3 of the swing door leaf 1 closes against, and preferably locks with, the opposing edge of the door frame 2.

When the swing door set is provided with two swing door leaves 1, as shown in FIG. 2, the swing door set may comprise either two identical swing door leaves 1a, 1b, arranged with their respective opening/closing edges 3 in close proximity to each other, or two swing door leaves arranged as a master swing door leaf 1a and a slave swing door leaf 1b.

When the swing door set comprises a master swing door leaf 1a and a slave swing door leaf 1b, the master swing door leaf 1a is provided with a flange extending along its main opening/closing edge 3. The flange of the master swing door leaf 1a will protrude over the main opening/closing edge 3 of the slave swing door leaf 1b, when both swing door leaves 1a, 1b are in the fully closed position. With such an arrangement, the swing door leaves 1a, 1b can be pushed open in one direction only, preferably from the inside of a room or building in a direction outwards towards the exterior, a corridor, or an evacuation route. The main opening/closing edge 3 of the master swing door leaf 1a closes against, and preferably locks into, the opposing opening/closing edge, i.e. the main opening/closing edge 3, of the slave swing door leaf 1b.

The term “open position” means any swing door leaf position other than the closed position. “Fully open position” is the position where the swing door leaf is in its end position, limited only by the building structure around the door frame, which can be up to 180° from the closed position. “Closed position” or “fully closed position” means the position where the swing door leaf closes the door opening completely.

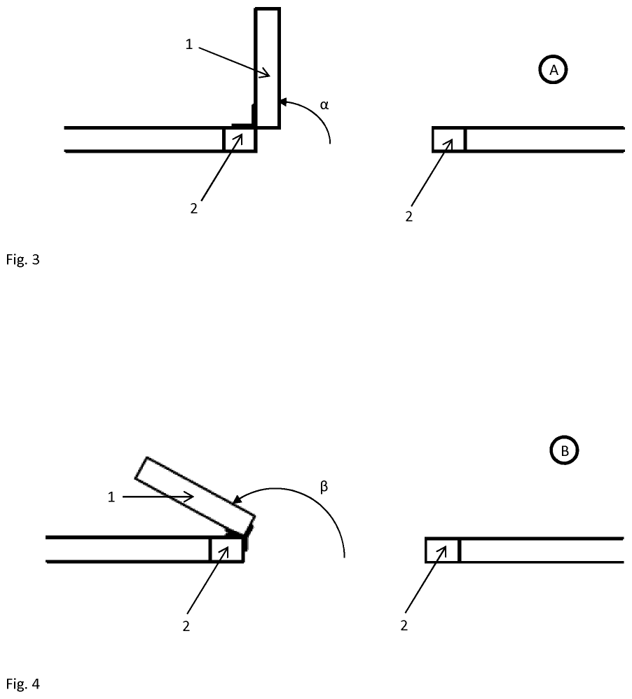

Below, three different swing door leaf positions are discussed, i.e. the closed position C, the first open position A, and the second open position B. The closed position C means that the swing door leaf is arranged at a 0° angle in relation to the surrounding building walls. The first open position A means that the swing door leaf is opened to an angle α of approximately 80-110°, which is the common door opening angle during regular use. This is shown in FIG. 3. The second open position B means that the swing door leaf is opened to an angle β, more than 110° but usually less than 180° due to the adjacent walls. This is shown in FIG. 4.

As previously mentioned, the swing door set may comprise one swing door leaf or two adjacent swing door leaves. The discussion below will primarily focus on an embodiment having only one swing door leaf 1, however, an embodiment having two swing door leaves 1a, b functions according to the very same principles. The two swing door leaves 1a, b may be adapted such that they open to different positions. One swing door leaf 1a may open only 90° while the other swing door leaf 1b opens 180°, e.g. when the swing door set is arranged at the very end of a corridor.

The swing door set comprises, i.a., a swing door leaf 1 and a swing door operator which controls the movement of the swing door leaf 1. The swing door operator is connected to at least one safety sensor for detecting objects, e.g. humans, located in the opening path of the swing door leaf 1. Further, the swing door operator is adapted to employ a first predetermined speed trajectory, or a first and a second predetermined speed trajectory in sequence, when pivoting the swing door leaf 1, i.e. opening the door. The first predetermined speed trajectory comprises moving the swing door leaf 1 from the closed position C to the first open position A. The second predetermined speed trajectory comprises moving the swing door leaf 1 from the first open position A to the second open position B. In other words, the angle α, β to which the swing door leaf 1 is opened is larger for the second open position B than the first open position A, as described above. The first and second predetermined speed trajectories are calculated, taking into account, e.g., the size and weight of the door leaf and the capacity of the motor which drives the door leaf.

The first predetermined speed trajectory is initiated, by the swing door operator, in response to an opening command or an evacuation command and is performed at full energy performance and with fully active safety sensors. The second predetermined speed trajectory is initiated, by the swing door operator, only in response to an evacuation command and is performed at low energy performance and with inhibited safety sensors.

An opening command is sent to the swing door operator when it has been registered that an individual approaches the swing door set in question, e.g. by means of sensors, a push button, a pushing action on the door leaf, or other kinds of access control. An evacuation command is sent to the swing door operator in response to, e.g., a fire alarm or other evacuation signal.

Full energy performance means that the swing door leaf 1 is opened at a speed which is normal for the specific swing door leaf 1 in question, with safety sensors active in order to detect obstacles in the opening path. Low energy performance means that the swing door leaf 1 is opened at a reduced kinetic energy setting compared to full energy performance, more specifically with a maximum kinetic energy of 1.69 J. Hence, the swing door set fulfils current standards without using safety sensors while opening the swing door leaf 1 farther than to the regular, first open position A.

When an opening command, or an evacuation command, has been received by the swing door operator, the swing door leaf 1 is moved, using the first predetermined speed trajectory, from its closed position C, at 0°, to the first open position A, at an angle α of preferably 80-110°, allowing one or several individuals, vehicles or the like, to pass through the door opening. When the opening command is no longer received by the swing door operator, closing of the swing door leaf 1 is initiated. Closing may also be initiated by means of an active closing command, or automatically when a predetermined time interval has passed from the time of receiving the opening command.

When an evacuation command has been received by the swing door operator, and the swing door leaf 1 reaches the above mentioned first open position A, the swing door operator inhibits the safety sensors while continuing to move the swing door leaf 1, using the second predetermined speed trajectory, from the first open position A to the second open position B at an angle β of preferably 110-180°. When the evacuation command is no longer received by the swing door operator, closing of the swing door leaf 1 is initiated. Closing may also be initiated by means of an active closing command, or automatically when a predetermined time interval has passed from the time of receiving the opening command.

As previously mentioned, a swing door set comprises of at least one swing door leaf 1 and at least one swing door operator. The swing door set preferably comprises of one of the following combinations: one swing door leaf 1 and one swing door operator or two swing door leaves 1a, b and two swing door operators, each swing door leaf 1a, b having its own swing door operator.

The person skilled in the art realizes that the present invention by no means is limited to the preferred embodiments described above. On the contrary, many modifications and variations are possible within the scope of the appended claims. For example, the any suitable number and combination of swing door leaves and swing door operators may be used. Also, when having a plurality of door leaves, the door leaves may be opened simultaneously or with some delay.

1. A swing door operator adapted for employing a first and a second predetermined speed trajectory in sequence, when operating at least one swing door leaf (1), said first predetermined speed trajectory comprising said swing door leaf (1) being moved from a closed position (C) to a first open position (A), and said second predetermined speed trajectory comprising said swing door leaf (1) being moved from said first open position (A) to a second open position (B) at a reduced kinetic energy setting, wherein said first speed trajectory is initiated in response to an opening command or an evacuation command received by said swing door operator, and wherein said second speed trajectory is initiated in response to an evacuation command received by said swing door operator, when said door leaf (1) arrives at said first open position (A).

2. A swing door operator according to claim 1, wherein said first open position (A) comprises said swing door leaf (1) being arranged at a first angle (a), and said second open position (B) comprises said swing door leaf (1) being arranged at a second angle (β) which is larger than said first angle (a).

3. A swing door operator according to claim 1, wherein said swing door operator comprises at least one safety sensor for detecting objects located in an opening path of said swing door leaf (1), said safety sensor being fully active during said first predetermined speed trajectory, and being inhibited when said swing door leaf (1) arrives at said first open position (A) and an evacuation command has been received by said swing door operator.

4. A swing door operator according to claim 1, wherein said swing door leaf (1) is moved with a maximum kinetic energy of 1.69 J during said second predetermined speed trajectory.

5. A swing door set comprising at least one swing door leaf (1) and at least one swing door operator according to claim 1.

6. Method of operating at least one swing door leaf during evacuation of a building, said method comprising the steps of
a) at least one swing door operator receiving one of an opening command and an evacuation command,
b) said at least one swing door operator moving said at least one swing door leaf (1), along a first predetermined speed trajectory, from a closed position (C) to a first open position (A) in response to one of said opening command and said evacuation command,
c1) wherein said door leaf (1), when arriving at said first open position (A) after an opening command, remains at said first open position (A), and
c2) wherein said door leaf (1), when arriving at said first open position (A) after an evacuation command, is moved at a reduced kinetic energy setting, along a second predetermined speed trajectory, from said first open position (A) to a second open position (B).

7. Method of operating at least one swing door leaf according to claim 6, wherein said first open position (A) comprises said at least one swing door leaf (1) being arranged at a first angle (a), and said second open position (B) comprises said at least one swing door leaf (1) being arranged at a second angle (β) which is larger than said first angle (a).

8. Method of operating at least on swing door leaf according to claim 6, further comprising the step of initiating movement of said at least one swing door leaf (1) from said first or second open position (A, B) to said closed position (C), when an opening command or an evacuation command no longer is received by said at least one swing door operator.
